(19) United States
(12) Patent Application Publication
(10) Pub. No.: US 2007/0184273 A1
(43) Pub. Date: Aug. 9, 2007

(54) Overmolding of Inserts

(75) Inventors: Jeffrey D. MacDonald, North York (CA); Richard P. Sieradzki, Frankfort, IL (US); Siegfried Niedermair, Sharon (CA); Sotirakis Michael, Canton, MI (US); Peter J. Dungar, Maumee, OH (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/350,141

(22) Filed: Feb. 9, 2006

(51) Int. Cl. B32B 9/04; B29C 45/14

(52) U.S. Cl. 428/411.1; 264/259; 425/542; 425/574; 425/576

(57) ABSTRACT

Disclosed herein are molding systems. A molding system includes a primary mold half, and also includes a secondary mold half configured to define a mold surface configured to have a formable insert formed thereon. The secondary mold half is also configured to move relative to the primary mold half. The secondary mold half is also configured to mold, in cooperation with the primary mold half, a molding material onto the insert formed onto the mold surface.

### TECHNICAL FIELD

The present invention generally relates to, but is not limited to, molding systems, and more specifically the present invention relates to, but is not limited to, overmolding of inserts.

### BACKGROUND

A thermoforming process produces plastic articles from flat, unformed sheets by pressing or squeezing pliable plastic into a final shape. In its simplest concept, thermoforming involves heating a sheet of thermoplastic, then positioning the sheet over a mold shape or a mold surface, then form fitting the sheet to a contour of the mold surface by using vacuum-generating or pressure-generating mechanisms.

The automotive industry uses film inserts to decorate molded articles. These film inserts are arranged in sheets that are individually thermoformed into a predetermined shape that (ideally) conforms to a mold surface of a mold half. Once enough film inserts have been thermoformed, a robotic assembly places them onto the mold surface of the mold half, then a molding machine overmolds or back-molds a molding material onto the thermoformed film insert. The result produces a molded plastic article that may appear to have a painted finish (or other surface quality that adds a surface finish) but it is the film insert that has been overmolded. The advantages of this approach over traditional painting processes are: lowered investment by eliminating costly paint booths; reduced manufacturing cost by cutting the need to dispose paint volatiles according to an environmentally-sensitive way, lowered manufacturing cost by using a contained and controllable closed-loop process, and improved product quality since the molded articles are made by a repeatable process.

Decorative film inserts have been used successfully on small parts and large parts, such as automobile bumper fascias. However, known apparatus and processes for molding articles having film inserts are plagued with disadvantages. Film inserts for larger articles with a deep draw may be difficult to form to the mold surface as shrinkage and conformity to deep bends and corners of a mold cavity proves difficult. In some processes, film inserts are formed on a first mold surface then later placed onto a second mold surface that was not originally used for thermoforming the insert. Accurate placement of thermoformed film inserts into mold surfaces is more of an art than a predicable science and thus higher scrap rates may result. Also, thermoformed film inserts usually do not conveniently and uniformly conform to the second mold surface and this may lead to a lower-part quality.

U.S. Pat. No. 5,989,480 (Inventor: Yamazaki; Assignee: Nissha Printing Company Limited, Japan) discloses a process for molding of decorated articles. An unformed film insert is placed over a mold half, held in place, then heated so the film insert becomes pliable. Then, a vacuum pulls the heated film insert into a form-fitting contact with a mold surface. Once a complimentary mold half is closed over the mold half, molten resin is injected. and a film-coated molded article is produced. Disadvantageously, the sequential steps of form fitting the film insert to the mold surface and overmolding requires a long-cycle time. A possible solution, that may be easily apparent to those skilled in the art faced with improving productivity, is to introduce a second molding machine cooperating with added mold halves. Although productivity may be improved, the added molding machine would increase capital, manufacturing and maintenance costs, and added space would be called for to house and run the added molding machine.

U.S. Pat. No. 5,728,409 (Inventor: Schad et al; Assignee: Husky Injection Molding Limted, Canada) discloses a turret-style molding machine that cooperates with an insert-loading apparatus that loads a formed insert onto an offline mold surface before molding the formed insert. The formed insert was formed by another machine. The formed insert, however, is not formable, and, as well, the formed insert does not suitably conform to the offline mold surface. The turret-style molding machine improves cycle time since it loads the formed insert onto an offline mold surface while molding the articles by way of another mold surface that was previously loaded with a new formed insert. Disadvantageously, this arrangement may increase inventory and handling costs because the formed inserts need to be produced and stored until they are called for, then they are transported to the molding machine (for overmolding). Possible solutions to this problem that may be apparent to those skilled in the art are: to use a second machine with the inherent disadvantages as previously mentioned, and/or to outsource production of the formed inserts that may (disadvantageously) result in longer production times and raised manufacturing costs.

U.S. Pat. No. 6,251,333 (Inventor: Zheng et al; Assignee: Ford Motor Company, U.S.A.) discloses a method for manufacturing a film-covered article. A thermoplastic film sheet is first heated then placed over a mold half. A sealing member closes and firmly holds the heated film in place by using a positive-air pressure applied in the mold or by using a negative-air pressure applied to create a vacuum, which causes the heated film to conform (ideally) to a mold surface. Molten resin is then injected into the mold cavity to create the film-covered article. Disadvantageously, this method uses sequential steps to load the film and inject molten resin onto the film, which results in increased cycle time for manufacturing articles. The sealing members increase mechanical complexity of the molding apparatus, cycle time and the cost of retrofitting molding machines. An alternative, that may be apparent to those skilled in the art, may be to cutout the sealing members and only rely on a positive-air pressure or a negative-air pressure to form the insert onto the mold surface. Although this arrangement appears to cut the cost of the molding machine, it does not overcome increased cycle time associated with the sequential approach of forming and molding (that is, the molding step can only occur once the forming step is finished).

U.S. Pat. No. 6,416,306 (Inventor: Oono et al; Assignee: Dai Nippon Printing Company Limited, Japan) discloses using a film-suppressing frame to accurately place a film insert before injecting molding material to the film insert. A feeding mechanism feeds the film insert from a roll between two open mold halves until the film insert is formed on a female mold half. The film-suppressing frame, which advances from and retracts to the female mold half, holds the film insert in place by pressing against the female mold half, vacuum forms the film, and inject a molten material against the formed film insert (and a film-coated article is formed as a result). It would be apparent to those skilled in the art to modify the frame until suitable operation may be attained. This approach, disadvantageously, also provides a sequential method of molding film-coated articles and thus has a long-cycle time associated with using the frame. The retractable film-suppressing frame needs complicated control elements and also needs potentially costly machining to have the frame installed in molding machines.

U.S. Pat. No. 6,221,304 (Inventor: Harris et al; Assignee: Visteon Global Technologies Incorporated, U.S.A.) discloses a method for manufacturing a film-coated article by placing a molded film or a formed film into a loading station. The molded film is placed onto the loading station by an operator and is transferred by the loading station to a robotic arm. The arm carries the molded film into the mold and loads it into the mold cavity. The mold closes, molten resin is injected and a film-covered article is formed. To cut cycle time, the robotic arm is double sided and configured such that one side loads films into a cavity side of the complementary mold halves while the other side removes molded parts from a core side of the complementary mold halves. Disadvantageously, this arrangement requires that the film is formed before the film is loaded into one of the complementary mold halves. As a result inventory and handling costs are incurred since films need to be produced, stored and later transported to the complementary mold halves when it is time to manufacture molded articles that incorporate the film. Although a solution, as it may be apparent to those skilled in the art, may be replacing the operator with an automated mechanism (which improves cost and health and safety concerns), the inserts must still be formed, stored and transported before making the molded article, and thereby this arrangement may incur increased cost and hampered production rates.

U.S. Pat. No. 5,728,409 (Inventor: Schad; Assignee: Husky Injection Molding Systems Limited, Canada) discloses a molding system that uses a non-formable liner. The liner is placed onto a molding surface and the liner is held to the molding surface by a vacuum that urges the insert to abut the mold surface. Disadvantageously, the insert does not conform to a molding surface, which may result in unaesthetic and unappealing molded articles.

U.S. Pat. No. 6,730,251 (Inventor: Eschenfelder et al; Assignee: Serigraph Inc., U.S.A.) discloses an apparatus in which an insert is formed on a mold half in cooperation with a mold half of a forming station. The formed insert is then removed from the mold half, and then it is placed into a mold half of a cutting/molding station in which the formed insert is overmolded by the mold half. The formed insert may not properly fit into the mold half, and thus a potentially defective part may be made when the formed insert is overmolded.

### SUMMARY

According to a first aspect of the present invention, there is provided a molding system, including a primary mold half, and a secondary mold half configured to (i) define a mold surface configured to have a formable insert formed thereon, (ii) move relative to the primary mold half, and (iii) mold, in cooperation with the primary mold half, a molding material onto the insert formed onto the mold surface, and the molding system also including an injection unit configured to inject the molding material into a cavity defined by the primary mold half and the secondary mold half, and the molding system also including an insert-forming assembly configured to form the formable insert onto the secondary mold half.

According to a second aspect of the present invention, there is provided a molding system, including a primary mold half configured to cooperate with a secondary mold half, the secondary mold half configured to (i) define a mold surface configured to have a formable insert formed thereon, (ii) move relative to the primary mold half, and (iii) mold, in cooperation with the primary mold half, a molding material onto the insert formed onto the mold surface.

According to a third aspect of the present invention, there is provided a molding system, including a secondary mold half configured to (i) cooperate with a primary mold half, (ii) define a mold surface configured to have a formable insert formed thereon, (iii) move relative to the primary mold half, and (iv) mold, in cooperation with the primary mold half, a molding material onto the insert formed onto the mold surface.

According to a fourth aspect of the present invention, there is provided a molding system, including an insert-forming assembly configured to form a formable insert onto a secondary mold half, the secondary mold half configured to (i) define a mold surface configured to have a formable insert formed thereon, (ii) move relative to a primary mold half, and (iii) mold, in cooperation with the primary mold half, a molding material onto the insert formed onto the mold surface.

According to a fifth aspect of the present invention, there is provided a molding system, including an injection unit configured to inject molding material into a cavity defined by a primary mold half and a secondary mold half, the secondary mold half configured to: (i) define a mold surface configured to have a formable insert formed thereon, (ii) move relative to the primary mold half, and (iii) mold, in cooperation with the primary mold half, a molding material onto the insert formed onto the mold surface.

According to a sixth aspect of the present invention, there is provided a manufactured article, including a body including a molding material molded relative to a formable insert, the body molded by a molding system having a primary mold half and having a secondary mold half, the secondary mold half configured to: (i) define a mold surface configured to have the formable insert formed thereon, (ii) move relative to the primary mold half, and (iii) mold, in cooperation with the primary mold half, the molding material onto the insert formed onto the mold surface.

According to a seventh aspect of the present invention, there is provided a molding process, including configuring a primary mold half to cooperate with a secondary mold half, defining a mold surface on the secondary mold half to have a formable insert formed thereon, moving the secondary mold half relative to the primary mold half, and molding, in cooperation with the primary mold half, a molding material onto the insert formed onto the mold surface of the secondary mold half.

According to an eighth aspect of the present invention, there is provided an article of manufacture for directing a data processing system to control a molding system operatively connected to the data processing system, the article of manufacture including a data processing system usable medium embodying one or more instructions executable by the data processing system, the one or more instructions including instructions for directing the data processing system to control a primary mold half in cooperation with a secondary mold half, and instructions for directing the data processing system to control the secondary mold half to (i) define a mold surface configured to have a formable insert formed thereon, (ii) move relative to the primary mold half, and (iii) mold, in cooperation with the primary mold half, a molding material onto the insert formed onto the mold surface.

A technical effect of the exemplary embodiments (at least in part) is the provision of a lower-cost approach to overmolding a molding material onto a formable insert. This approach avoids inventory costs associated with handling and storing the insert before overmolding them. In addition, these arrangements avoid problems related to making inserts on a mold surface and then expecting them to fit into another mold surface used to overmold molding material on to the insert.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIGS. 1A to 1F are side views of a molding system according to a first embodiment;

FIG. 2 is a side view of a molding system according to a second embodiment;

FIG. 3 is a side view of a molding system according to a third embodiment;

FIG. 4 is a side view of a molding system according to a fourth embodiment;

FIG. 5 is a side view of a molding system according to a fifth embodiment;

FIG. 6 is a side view of a molding system according to a sixth embodiment; and

FIGS. 7A to 7E are side views of a molding system according to a seventh embodiment.

The following is a list of components used in the FIGS.:

molding system 10
primary mold half 12
set of mold halves (14A, 14B)
secondary mold half 14A
secondary mold half 14B
formable inserts 16A, 16B, 16C, 16E off-cast 16D
molding material 18A, 18B
mold-moving assembly 20
frame assembly 22
tie bars 24A
tie bars 24B
stationary platen 26
injection unit 28
base 30
barrel assembly 32
hopper assembly 34
processing screw 36
nozzle assembly 38
sprue mechanism 40
screw control mechanism 42
insert-forming assembly 44
end-of-arm tool 46
molded-article removing assembly 48
insert-handling assembly 50
frame members 52A, 52B
heater assembly 54
cutters 56A, 56B
heaters 58A, 58B
air passage channels 60A, 60B
molding system 61
set of secondary mold halves 62
secondary mold halves 62A, 62B, 62C, 62D
molding system 64
molding system 66
insert-forming assembly 68
die-cutting assembly 70
molding system 72
insert-forming assembly 74
heat circulation system 76
perimeter cutter 78
die cutter 80
molding system 100
primary mold half 102
secondary mold half 104
inline position 106
off-line position 108
mold surface 110
insert 112
molding system 200
primary mold half 202
secondary mold half 204A
secondary mold half 204B
mold surface 206A
mold surface 206B
formable insert 208A
formable insert 208B
molding material 210
stationary platen 212
frame 214
injection unit 216
EOAT (end-of-arm tool) 218
mold-moving assembly 220
pivot 222
insert-forming assembly 224
paint-spraying mechanism 226
paint-removing assembly 228

### DETAILED DESCRIPTION OF THE EXEMPLARY EMBODIMENTS

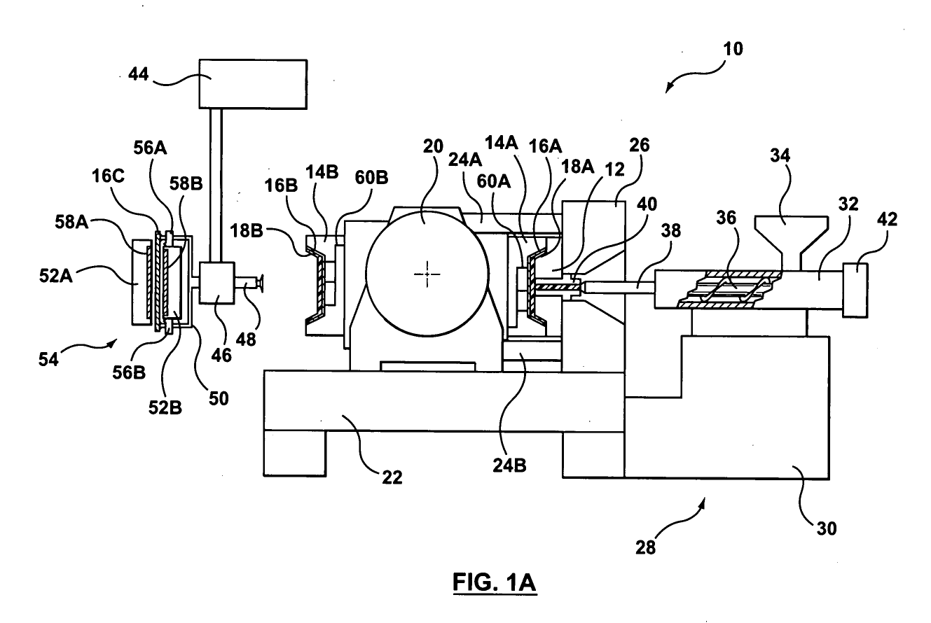

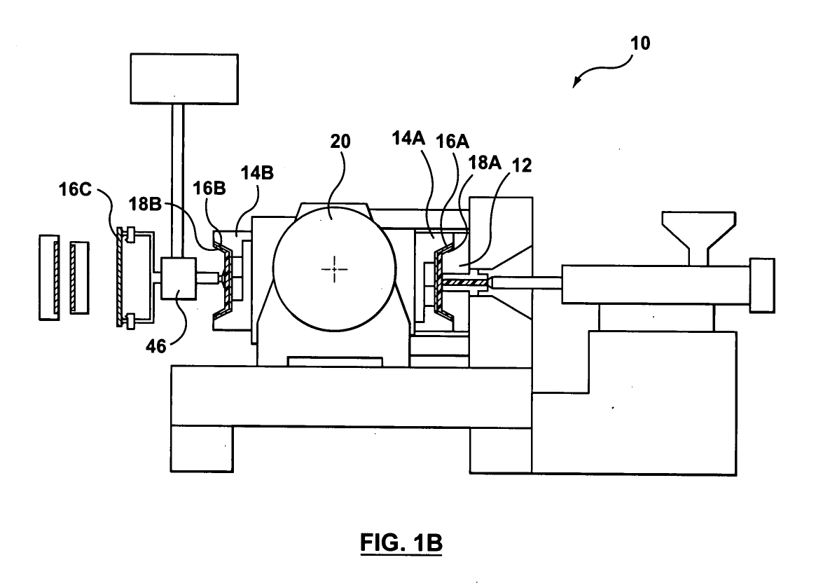

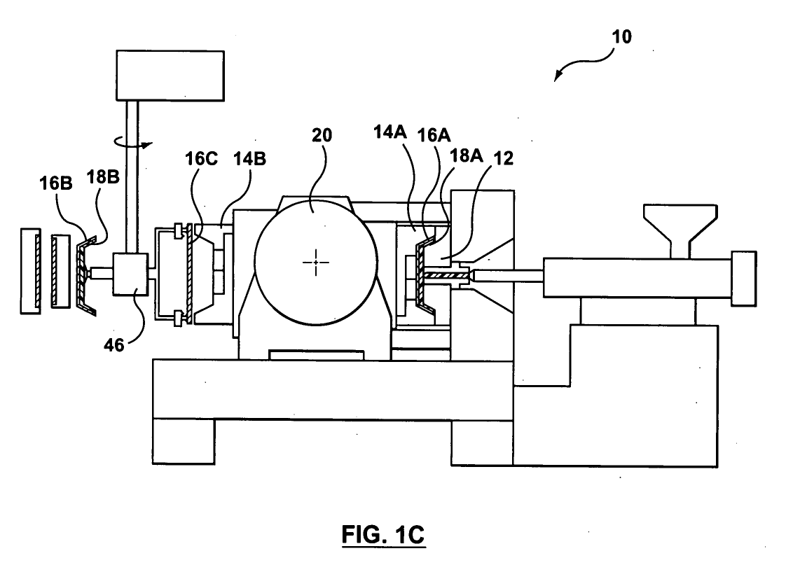

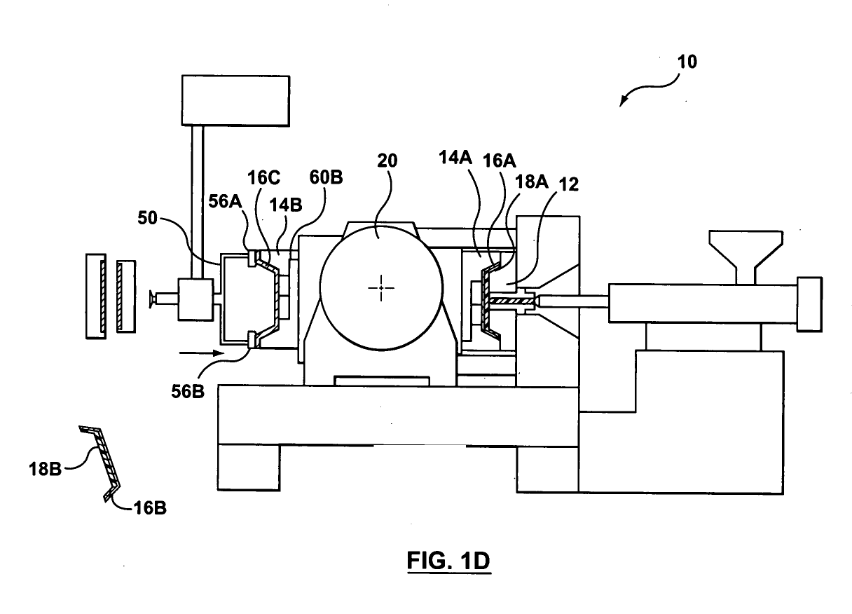

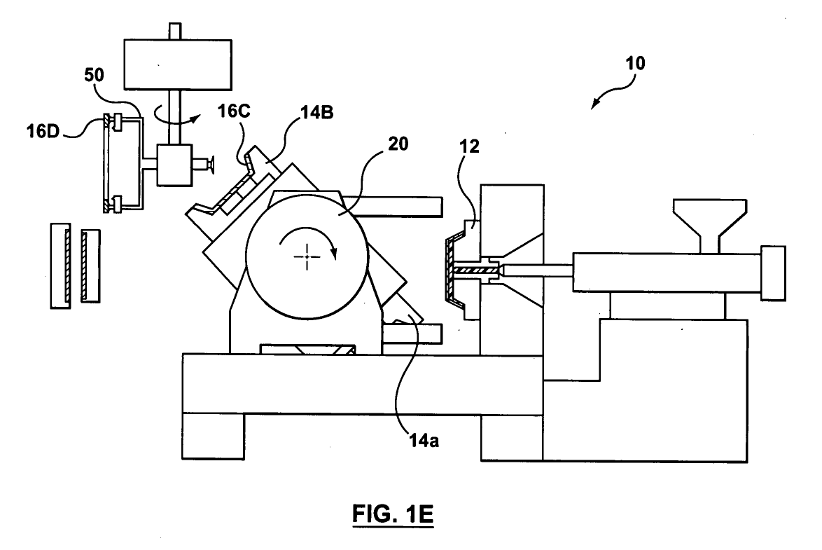

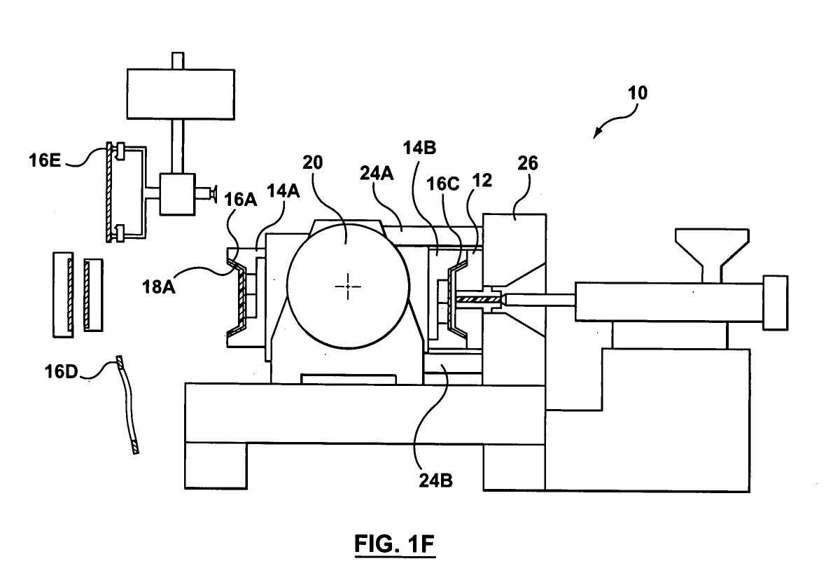

FIGS. 1A to 1F are side views of a molding system 10 according to the first embodiment, which is the preferred embodiment.

FIG. 1A shows the molding system 10 that include a primary mold half 12. The molding system 10 also includes a set of secondary mold halves (14A, 14B). According to the embodiment depicted in FIG. 1A, the secondary mold halves (14A, 14B) include two mold halves, as follows: a secondary mold half 14A and a secondary mold half 14B. The secondary mold half 14A and the secondary mold half 14B each include a mold surface. In other embodiments, the secondary mold halves include a set of four mold halves. It will be appreciated that two or more mold halves may be included in the set of secondary mold halves according to a configuration of the molding system 10 configured to mold articles according to a desired manufacturing cycle time, a desired production quantity, etc.

In operation, the secondary mold half 14A defines a mold surface configured to have a formable insert 16A formed thereon. The secondary mold half 14A is movable relative to the primary mold half 12. The secondary mold half 14A molds (and/or overmolds), in cooperation with the primary mold half 12, a molding material 18A onto the insert 16A.

The secondary mold half 14B defines a mold surface configured to have a formable insert 16B formed thereon. The secondary mold half 14B is movable relative to the primary mold half 12. The secondary mold half 14B molds, in cooperation with the primary mold half 12, a molding material 18B onto the insert 16A. In alternative embodiments (described below), each secondary mold half of the secondary mold halves defines a mold surface that is configured to have a formable insert thermo-formed thereon, or the mold surface is configured to have a formable insert cold-formed thereon (or any combination and permutation of thermo-forming and cold forming).

According to one alternative, the components of the molding system 10 are supplied separately from the primary mold half 12, the secondary mold half 14A and the secondary mold half 14B. According to another alternative, the components of the molding system 10 are supplied in combination with the primary mold half 12, the secondary mold half 14A and the secondary mold half 14B.

According to the embodiment depicted in FIG. 1A, the secondary mold half 14A and the secondary mold half 14B are attached to a mold-moving assembly 20 that is supported by a frame assembly 22. The mold-moving assembly 20 is used for moving the mold halves 14A and 14B. The frame assembly 22 includes mechanisms (not depicted: such as linear bearings) that permit the mold-moving assembly 20 to slide or to translate along the frame assembly 22 toward and away from the primary mold half 12 in a reciprocating motion. A translating mechanism (not depicted) translates the mold-moving assembly 20 about the frame assembly 22 so that the mold-moving assembly 20 is translatable along a translation axis. A rotating mechanism (not depicted) rotates the mold-moving assembly 20 along a rotation axis that extends perpendicularly from the translation axis (that is, the rotation axis extends orthogonally from FIG. 1A). The mold-moving assembly 20 (in cooperation with the translating mechanism and the rotating mechanism) translates and rotates the secondary mold half 14A and secondary mold half 14B between an offline position (that is, offline from the primary mold half 12) and an inline position (that is, inline with the primary mold half 12). FIG. 1A depicts the secondary mold half 14A placed in the inline position (that is, the secondary mold half 14A is placed inline with the primary mold half 12), and depicts the secondary mold half 14B placed in the offline position (that is, the secondary mold half 14B is placed offline relative to the primary mold half 12).

Attached to the mold-moving assembly 20 is a pair of tie bars 24A and a pair of tie bars 24B each of which extends from the mold-moving assembly 20 toward a stationary platen 26. The stationary platen 26 is attached to and extends from the frame assembly 22. The stationary platen 26 includes a clamping assembly (not depicted). The clamping assembly receives the tie bars 24A and the tie bars 24B when the mold-moving assembly 20 is moved over to the stationary platen 26. The clamping assembly applies a clamping force along the tie bars 24A and the tie bars 24B once the clamping assembly receives the tie bars 24A and the tie bars 24B. The translating mechanism, at first, moves the secondary mold half 14A over to abut against the primary mold half 12 and the tie bars 24A and 24B engage the clamping assembly. Then the clamping assembly is energized to pull the tie bars 24A and the tie bars 24B toward the stationary platen 26, and in turn the secondary mold half 14A becomes clamped to the primary mold half 12 before a molding material may be molded to the insert 16A that is formed onto the secondary mold half 14A.

Movement of the mold-moving assembly 20 is such that a selected one of the secondary mold half 14A and the secondary mold half 14B is made to abut against and cooperate with the primary mold half 12. In the inline position, the combination of the clamping assembly and the tie bars 24A, 24B apply enough clamping force to keep the primary mold half 12 and the secondary mold half 14A clamped together during a molding cycle while the secondary mold half 14A is positioned inline with the primary mold half 12.

The molding system 10 further includes an injection unit 28. The injection unit 28 includes a base 30. The injection unit 28 also includes a barrel assembly 32 that is attached to the base 30. Attached to the barrel assembly 32 is a hopper assembly 34. The barrel assembly 32 defines an internal chamber that is sized to receive a processing screw 36. Disposed at a tip of the barrel assembly 32 is a nozzle assembly 38. The nozzle assembly 38 dispenses a molding material into a sprue mechanism 40. The sprue mechanism 40 is disposed in the stationary platen 26, and is connected to a passageway defined in the primary mold half 12 so that the sprue mechanism 40 conveys a molding material over to the primary mold half 12 during an injection cycle of the injection unit 28. A screw control mechanism 42 is actuated to control the processing screw 36 by rotating and translating the processing screw 36.

In operation, a molding material (such as a plastic resin or a magnesium alloy) is introduced into the hopper assembly 34, which then feeds the molding material to the barrel assembly 32. Then, the molding material is processed by the processing screw 36 into a suitable condition. Then the processing screw 36 moves the molding material along the barrel assembly 32 toward the tip of the barrel assembly 32. Before an injection cycle of the injection unit 28 begins, a selected one of the secondary mold halves (depicted, the selected secondary mold half is the secondary mold half 14A) is clamped against the primary mold half 12. During the injection cycle, the nozzle assembly 38 is opened and the processing screw 36 is moved to force the molding material out from the barrel assembly 32 through the opened nozzle assembly 38 and into the sprue mechanism 40. The molding material becomes injected into a passageway defined by the primary mold half 12, and the passageway of the primary mold half 12 leads to a molding cavity defined by the primary mold half 12 and the secondary mold half 14A. Once the secondary mold half 14A receives the insert 16A formed thereon, the molding material is injected into the molding cavity. The injected molding material has now become overmolded onto the insert 16A.

The following describes an example of forming a formable insert onto the secondary mold half 14A and the secondary mold half 14B. An insert-forming assembly 44 sequentially forms a formable insert onto each mold surface of each secondary mold halves 14A, 14B. The insert-forming assembly 44 forms an insert onto the secondary mold half 14B that is placed in the offline position while the secondary mold half 14A is placed in the inline position for receiving molding material onto the insert 16A.

The insert-forming assembly 44 includes an end-of-arm tool 46 that supports a molded-article removing assembly 48. The molded-article removing assembly 48 removes a molded article from the secondary mold half 14B that is placed in the offline position. The end-of-arm-tool 46 also supports an insert-handling assembly 50 used to transfer a formable insert 16C between frame members 52A, 52B of a heater assembly 54. The insert-forming assembly 44 also includes a cutter 56A and a cutter 56B used to die cut the insert 16C (specifically, to trim a peripheral edge of the insert 16C). The frame member 52A and the frame member 52B (of the heater assembly 54) each include a heater 58A and a heater 58B respectively. The heater assembly 54 is configured to heat the insert 16C such that the insert 16C becomes pliable enough to become form fitted onto any one of the secondary mold halves 14A, 14B that is placed in the offline position.

Each of the secondary mold halves 14A, 14B defines an air-passage channel 60A and an air-passage channel 60B respectively. Attached to the channel 60A and the channel 60B is a differential-air-pressure mechanism (not depicted) that selectively draws air into the secondary mold halves 14A, 14B. When the insert-forming assembly 44 positions the heated insert 16C near the secondary mold half 14B, the differential-air pressure mechanism draws air from the channel 60B. The channel 60B draws in air to draw the heated insert 16C onto the mold surface defined by the secondary mold half 14B with enough force so that the insert 16C becomes formed into a surface-conforming relationship with the secondary mold half 14B. In an alternative, the heater assembly 54 is not used, and the formable insert 16C is formed onto the mold surface of the secondary mold half 14B by using differential-air pressure delivered by the channel 60A and the channel 60B. In an alternative, the insert-forming assembly 44 is adapted with air blowing mechanisms (not depicted) that blow (that is, by application of positive air pressure) the insert 16C onto the mold surface of the secondary mold half 14B (either with or without the aid of the heater assembly 54).

In an alternative, each of the insert-forming assembly 44, the mold halves 12, 14A, 14B, and the injection unit 28 are supplied separately. According to another embodiment, each of the insert-forming assembly 44, the mold halves 12, 14A, 14B, and the injection unit 28 are supplied in combination by a single vendor.

FIG. 1B shows the molded-article removing assembly 48 removing a previously molded material 18B from the secondary mold half 14B. Preferably, through a combination of suction and a mechanical gripper (or other removal devices), the molded-article removing assembly 48 grips the molding material 18B, then differential-air pressure supplied by the air channel 60B is de-actuated, which permits transfer of the molding material 18 away from the secondary mold half 14B.

FIG. 1C shows that once the molded-article removing assembly 48 engages the molding material 18B, the insert-forming assembly 44 retracts the molded-article removing assembly 48 from the secondary mold half 14B. Following removal of the molding material 18B, the heated insert 16C is aligned with the offline secondary mold half 14B. Once reaching a position having adequate clearance, the insert-forming assembly 44 rotates the end-of-arm-tool 46 such that the insert-handling assembly 50 is positioned to line up the heated insert 16C with the secondary mold half 14B.

FIG. 1D shows the insert 16C formed onto the secondary mold half 14B, and the molding material 18B ejected and falls onto a conveyor (not depicted). The insert-handling assembly 50 positions the insert 16C over the mold surface of the secondary mold half 14B. Once the insert. 16C is properly positioned, the air channel 60B is activated to create a vacuum between the insert 16C and the secondary mold half 14B. The vacuum causes the insert 16C to be drawn in and conform to the molding surface of the secondary mold half 14B (preferably in a mold-conforming relationship). Once the insert 16C has been formed, the cutter 56A and the cutter 56B are urged against the insert 16C to trim excess material from a peripheral edge of the insert 16C. The molded-article removing assembly 48 releases the molding material 18B by disengaging a retention means of the molded-article removing assembly 48 from the molding material 18B thus allowing the molding material 18B to fall onto a conveyor (not depicted) or other part-transfer system.

FIG. 1E shows the secondary mold halves 14A, 14B being moved or rotated between the inline and the offline positions. The secondary mold half 14A and the primary mold half 12 are de-clamped from each other. The mold cavity defined by the secondary mold half 14A and the primary mold half 12 is opened, the mold-moving assembly 20 retracts the secondary mold half 14B away from the primary mold half 12, then the mold-moving assembly 20 is rotated. The molding material 18A is retained on the secondary mold half 14A by a vacuum provided by the channel 60A. The mold-moving assembly 20 is then rotated about a horizontal axis that extends perpendicular from a direction along which the secondary mold half 14A and the primary mold half 12 were clamped and de-clamped. The secondary mold half 14B is moved from the offline position to the online position, and the secondary mold half 14A is moved from the online position to the offline position. This arrangement orients the previously offline secondary mold half 14B having the form fitted insert 16C into the inline position (that is, inline with the primary mold half 12). The channel 60B provides a vacuum for retaining the insert 16C relative to the secondary mold half 14B as the mold-moving assembly 20 is rotated. As the secondary mold half 14B is rotated into the inline position, the secondary mold half 14A is rotated into the offline position for article removal and subsequent preparation for receiving a fresh insert. During rotation of the mold-moving assembly 20, the insert-forming assembly 44 also rotates to switch the position of the insert-handling assembly 50 that holds an off-cast 16D that was cut away from the insert 16C. To avoid interference with a rotation of the mold-moving assembly 20, the insert-forming assembly 44 is retracts away to a safe position.

In an alternative embodiment, the mold-moving assembly 20 rotates about a vertical axis of rotation relative to the rotation axis depicted in FIGS. 1A to 1F.

FIG. 1F shows the secondary mold half 14B now positioned in the inline position and oriented to cooperate with the primary mold half 12. The secondary mold half 14A is now positioned in the offline position and is oriented to cooperate with the insert-forming assembly 44. The mold-moving assembly 20 is made to translate such that the secondary mold half 14B abuts against the primary mold half 12. The tie bars 24A, 24B are made to engage the clamping mechanism (not depicted) to provide clamping force for molding another molded article to the insert 16C. The off-cast 16D is released by the insert-forming assembly 44 and a new insert 16E is retrieved by the insert-forming assembly 44. The molding cycle may now be repeated.

A thermoforming process is used for form fitting the insert 16C to a mold surface. The thermoforming process includes forming and/or shaping a thermoplastic sheet into a three-dimensional shape by clamping the sheet (that is, the insert) in a frame, heating it to its forming temperature which makes the insert soft and flowable, and applying differential-air pressure (such as, for example, a vacuum) to make the sheet conform to the shape of a mold or die positioned beside the frame. Excess is then cut off the shaped sheet. In an alternative, a cold-forming process or a cold-stretching process or a cold-drawn process is used in place of a thermo-forming process, in which a heater is not used to heat the insert, but the insert is formed onto the mold surface.

The insert 16C is any one of a decorative sheet, a film, a fabric-laden sheet, a fabric, a decal, a painted film, a sheet, a laminated panel, a flat plate and any combination and permutation thereof. The fabric includes, optionally, a printed pattern. The fabric may be interior trim of an automobile, and may include multiple layers.

In an alternative (not depicted), the primary mold half 12 and the secondary mold halves (14A, 14B) (and any combination and permutation thereof) are configured to be supported and to be moved by the mold-moving assembly 20. Preferably, the mold-moving assembly 20 supports and moves the secondary mold half 14A and the secondary mold half 14B.

The mold-moving assembly 20 rotates along a horizontally-aligned rotation axis. In an alternative, the mold-moving assembly 20 rotates along a vertically-aligned rotation axis.

The primary mold half 12 includes a core side, and each of the secondary mold halves 14A, 14B includes a cavity side corresponding to the core side. In an alternative, the primary mold half 12 includes a cavity side, and each of the secondary mold halves 14A, 14B includes a core side corresponding to the core side.

Components depicted in FIGS. 1A to 1F may be supplied separately or may be supplied in any combination and permutation. According to an alternative, the primary mold half 12, the secondary mold halves 14A, 14B, the injection unit 28, and the insert-handling assembly 50, in any combination and permutation of these components, are supplied by many vendors, and an end-user combines these components or hires a system integrator to combine these components. According to another alternative, the primary mold half 12, the secondary mold halves 14A, 14B, the injection unit 28, and the insert-handling assembly 50 are supplied by a single vendor, and the single vendor combines these components for the end-user.

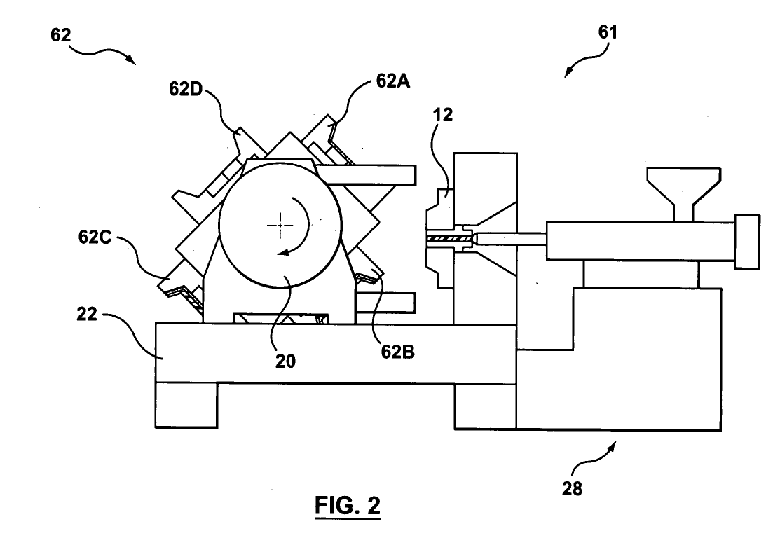

FIG. 2 is a side view of a molding system 61 according to the second embodiment. The molding system 61 includes a set of secondary mold halves 62. The set 62 includes secondary mold halves 62A, 62B, 62C and 62D. The mold-moving assembly 20 rotates the secondary mold halves 62A, 62B, 62C, 62D clockwise so that each is movable to four operating positions. FIG. 2 depicts each of the mold halves 62A, 62B, 62C and 62D rotated away from the four operating positions so that a clear view of each mold half may be presented. The four operating positions are: (i) a first position in which an insert is formed onto the secondary mold half 62A, and the mold half 62A faces upwardly, (ii) a second position in which the secondary mold half 62B forms and presents a formed insert, and a molding material is molded to the formed insert by the injection unit 28; the mold half 62B faces toward the injection unit 28, (iii) a third position in which the secondary mold half 62C has an insert molded to a molding material, and the molding material and the insert is permitted to cool off, and (iv) a fourth position in which a molded article including an insert is removed from the secondary mold half 64D.

The advantage of this embodiment is that a molding material overmolded onto an insert is permitted enough time to cool before being removed from a secondary mold half.

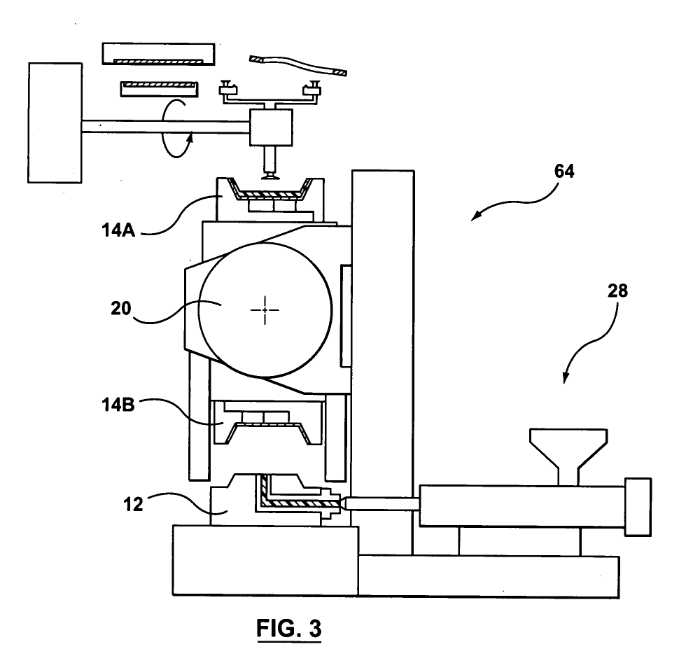

FIG. 3 is a side view of a molding system 64 according to the third embodiment. The molding system 64 is similar to the molding system 10, except that the secondary mold halves 14A, 14B are aligned vertically. The advantage of this embodiment is less factory floor space may be used. The secondary mold half 14A is shown receiving an insert and a molding material has been overmolded thereon. The secondary mold half 14B is shown receiving an insert and is in position to have a molding material overmolded onto its insert.

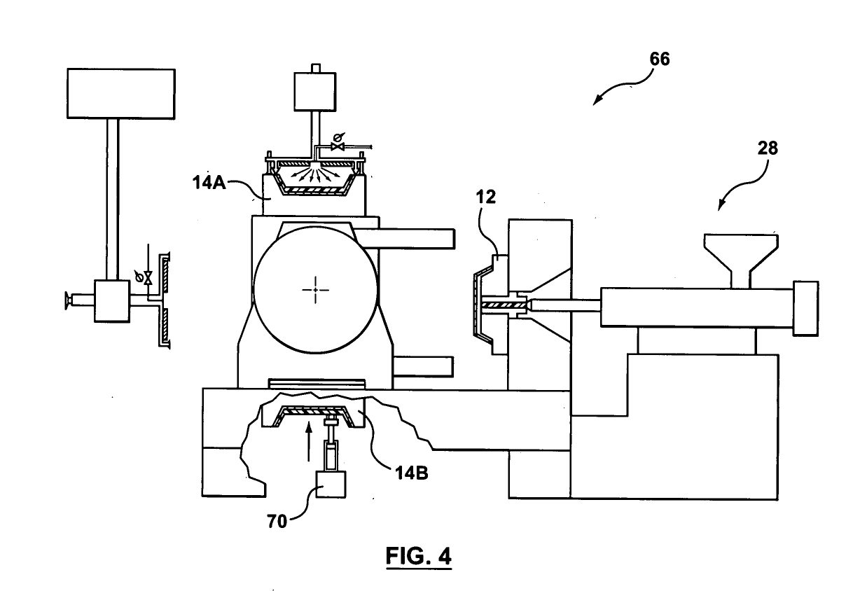

FIG. 4 is side view of a molding system 66 according to the fourth embodiment. An insert-forming assembly 68 receives a pressurized fluid that forms an insert onto the secondary mold half 14A. The advantage of this embodiment is that heat is not used to form an insert onto the secondary mold halves 14A, 14B since the insert is flexible enough and/or the fluid pressure is enough to form the insert against a mold surface. A die-cutting assembly 70 removes a portion of a molding material that is overmolded to an insert that is received by the secondary mold half 14B. The advantage of this embodiment is that portions may be removed from the molded material and the insert to accommodate desired automotive part finishes, such as dashboards, etc.

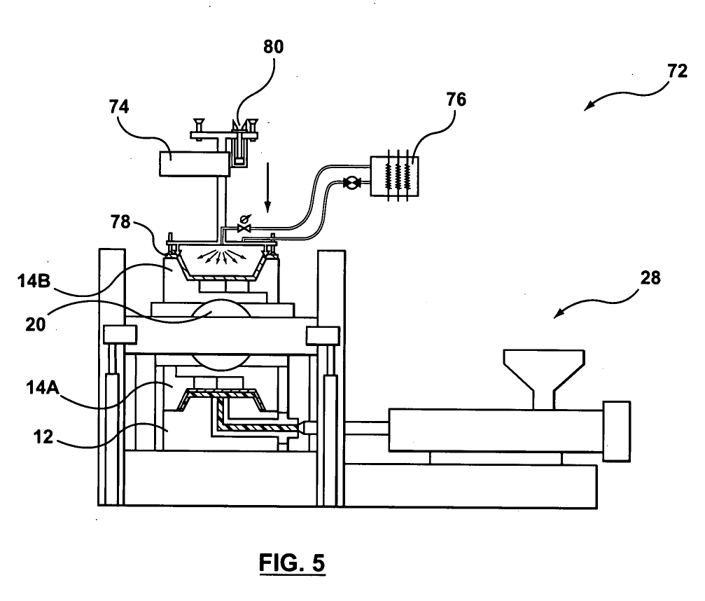

FIG. 5 is a side view of a molding system 72 according to the fifth embodiment. Secondary mold halves 14A, 14B are aligned vertically while the injection unit 28 is aligned horizontally. This approach reduces the floor space need by the molding system 10. An insert-forming assembly 74 cooperates with a heat-circulation system 76. The heat-circulation system 76 delivers a stream of hot air having enough heat to thermo-condition an insert and then has enough air-pressure, when so energized, to form the insert against a mold surface. The advantage of this embodiment is that the energy used to keep the air sufficiently heated in the system 74 is circulated and reused for heating and forming other inserts. This approach improves the energy management of the molding system 74. The insert-forming assembly 74 also includes a perimeter cutter 78 for cutting an outer perimeter of an insert. The insert-forming assembly 74 also includes a die cutter 80 for cutting an inner hole in a molded article overmolded onto an insert.

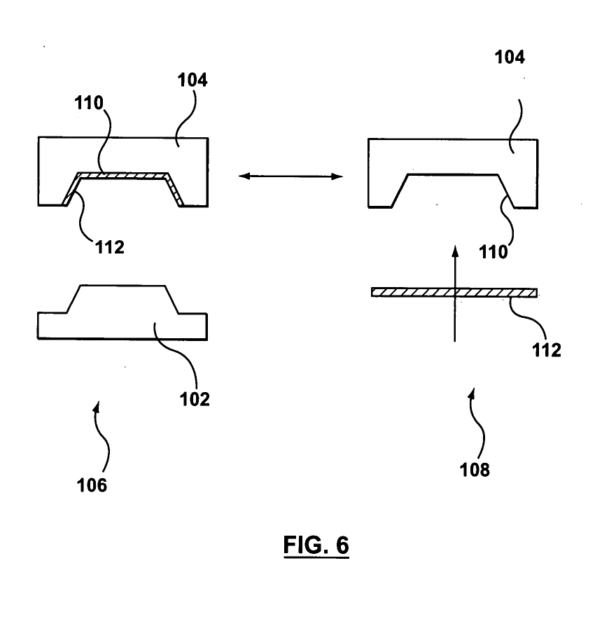

FIG. 6 is a side view of a molding system 100 according to the sixth embodiment. The molding system 100 includes a primary mold half 102, and also includes a secondary mold half 104. The secondary mold half 104 is movable relative to the primary mold half 102 between an inline position 106 and an off-line position 108. The secondary mold half 104 defines a mold surface 110 configured to have a formable insert 112 formed thereon in the off-line position 108. The secondary mold half 104 is also configured to mold in cooperation with the primary mold half 102, a molding material (not depicted) onto the insert 112 formed onto the mold surface 110 in the inline position 106. A mold moving assembly (not depicted) is used to move the mold halves 102 and 104 relative to each other. The primary mold half 102 includes a core side and the secondary mold half 104 includes a cavity side corresponding to the core side. In an alternative, the mold half 102 includes a cavity side and the mold half 104 includes the core side.

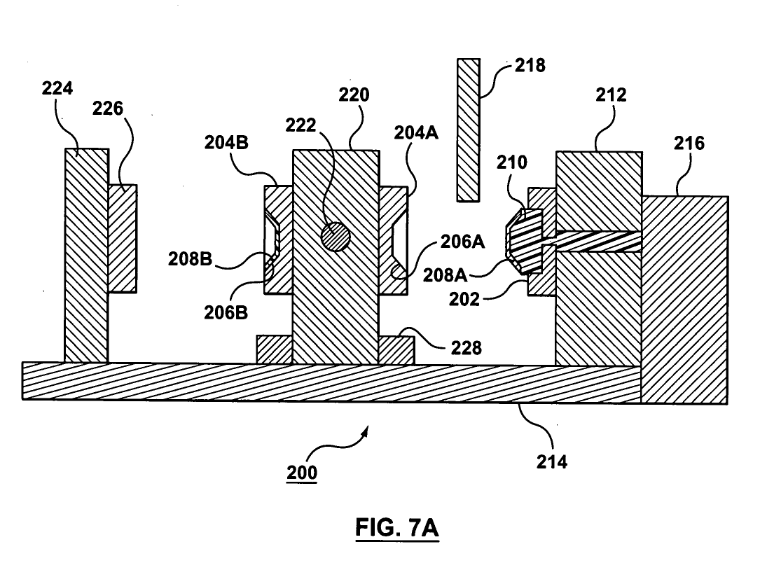

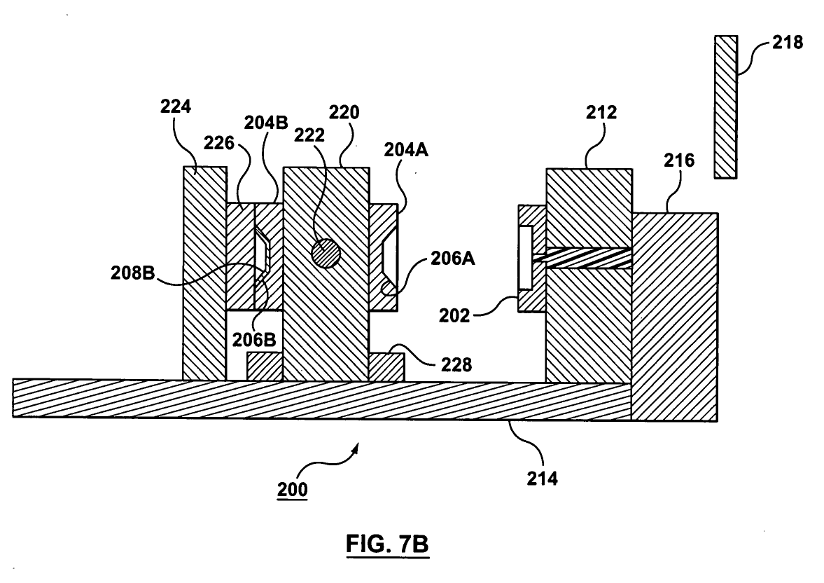

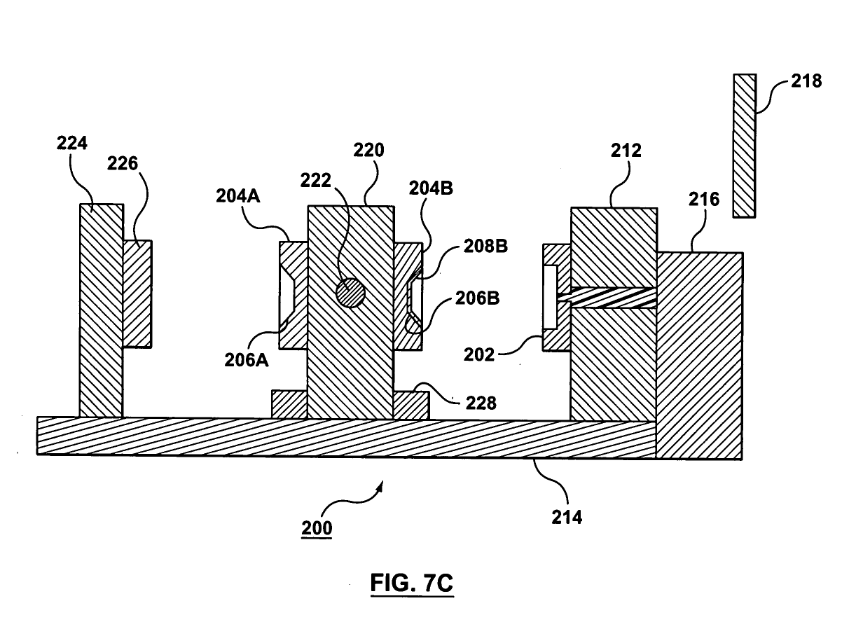

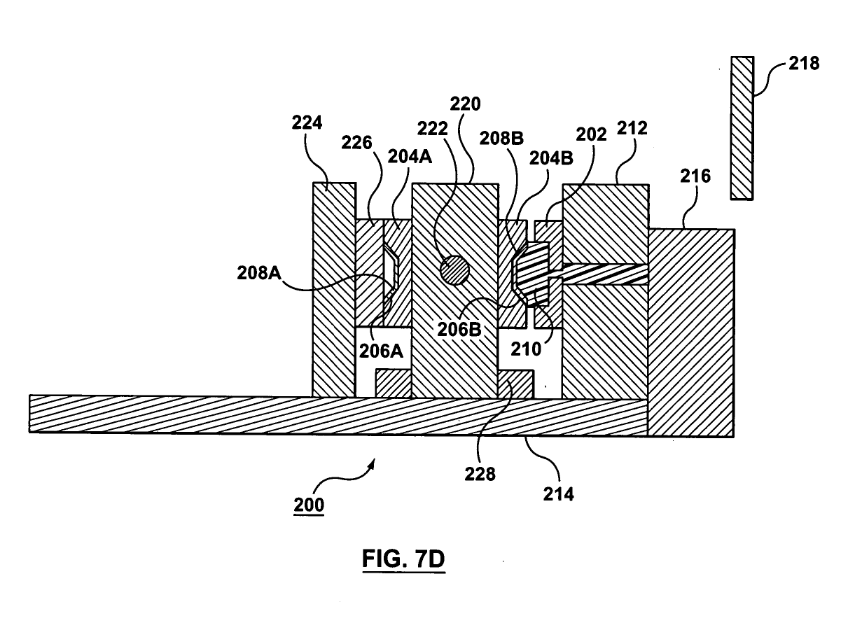

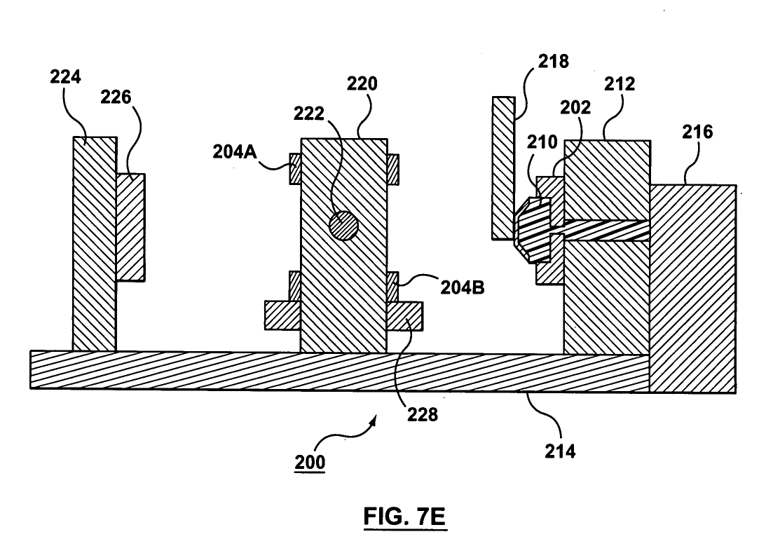

FIGS. 7A to 7E are side views of a molding system 200 according to the seventh embodiment, in which a molded article is manufactured by overmolding a molding material onto a coating placed into a mold surface. For example, the coating is a layer of paint that was painted or coated onto the mold surface. The molded article is, for example, a surface of an automobile or a vehicle, such as a front fascia, a rear fascia, an exterior surface or an interior surface of the vehicle. Briefly, the molding process includes the steps of opening a mold, applying a layer of paint to a mold surface of the opened mold, and waiting for the paint to cure. The molding surface is, for example, a surface of a cavity side of the mold. Further steps include closing the mold, applying a clamping force to the closed mold, and injecting a molding material into a mold cavity defined by the closed mold. According to an alternative, an injection/compression molding process is used to inject the molding material to the layer of paint. The layer of paint bonds to the molding material before the molding material cools down. Final steps include opening the closed mold and removing the molded article from the mold without damaging the painted surface or finish of the molded article.

FIG. 7A shows the elements of the molding system 200. The molding system 200 includes a primary mold half 202 and also includes secondary mold halves 204A, 204B. The secondary mold halves 204A, 204B each define mold surfaces 206A, 206B respectively. The mold surfaces 206A, 206B are each configured to have a formable insert 208A, 208B (respectively) formed thereon. The inserts 208A, 208B are layers of paint that were applied to the mold surfaces 206A, 206B (respectively) by a painting mechanism (the painting mechanism is described further below). The mold surfaces 206A, 206B are also configured to be movable (that is, translatable away from and toward) relative to the primary mold half 202. The mold surfaces 206A, 206B are also configured to mold, in cooperation with the primary mold half 202, a molding material 210 onto the inserts 208A, 208B formed onto the mold surface 206A, 206B respectively. The molding material 210 is depicted to be overmolded onto the insert 208A (that is, the layer of paint 208A), and this combination forms a molded article once the molding material 210 has cooled off. The primary mold half 202 is mounted to and attached to a stationary platen 212 that is fixedly attached to a frame 214. An injection unit 216 is used to inject molding material into a mold cavity formed when the primary mold half 202 is closed against the secondary mold half 204A (or is closed against the secondary mold half 204B). An EOAT (end-of-arm tool) 218 is used to remove the molded article 210 from the primary mold half 202 (preferably without scratching the insert 208A. Alternatively, the EOAT 218 removes the molded article 210 from the mold half 204A or 204B. A mold-moving assembly 220 is used to move the secondary mold halves 204A, 204B relative to the primary mold half 202. The secondary mold halves 204A, 204B are pivotally connected to the mold-moving assembly 220 at a pivot 222, so that the secondary mold halves 204A, 204B can be rotated to selectively face the primary mold half 202. An insert-forming assembly 224 is slidable along the frame 214, and the assembly 224 includes a paint-spraying mechanism 226. The paint-spraying mechanism 226 sprays paint onto the molding surfaces 206A, 206B. The mechanism 226 transfers paint fumes emitted by fresh paint over to a scrubber and filtering system (not depicted). A paint-removing assembly 228 is used to remove vestiges of paint and/or debris from the molding surfaces 206A, 206B. According to an alternative, the insert-forming assembly 224 includes a platen that is slidable or movable along the frame 214.

FIG. 7B shows a first phase of a molding cycle of the molding system 200 of FIG. 7A. The insert-forming assembly 224 translates the paint-spraying mechanism 226 over to the secondary mold half 204B. The mechanism 226 is sealed against the secondary mold half 204B, and then it sprays a layer of paint 208B (also known as the insert 208B) onto the mold surface 206B. The paint-spraying mechanism 226 vents or transfers VOCs (Volatile Organic Compounds) over to a scrubber and filtering system (not depicted). The system 200 waits for the layer of paint 208B to cure.

FIG. 7C shows a second phase of the molding cycle of the molding system 200 of FIG. 7A. The insert-forming assembly 224 translates the paint-spraying mechanism 226 away from the mold-moving assembly 220. Then, the mold-moving assembly 220 rotates the secondary mold halves 204A, 204B so that mold half 204A now faces the paint-spraying mechanism 226 while the mold half 204B faces the primary mold half 202.

FIG. 7D shows a third phase of the molding cycle of the molding system 200 of FIG. 7A. The mold-moving assembly 220 translates the secondary mold half 204B toward the primary mold half 202 and closes the mold half 204B against the mold half 202. The assembly 220 applies a clamping force to the mold halves 202, 204B. The injection unit 216 injects a molding material into a mold cavity defined by the mold halves 202, 204B, and a molding material becomes overmolded onto the layer of paint 208B. Preferably, as the assembly 220 translates the mold half 204B toward the mold half 202, the insert-forming assembly 224 translates the paint-spraying mechanism 226 over to and into contact with the mold half 204A so that a layer of paint 208A may be sprayed (by the mechanism 226) onto the mold surface 206A. VOCs are vented from the layer of paint surface 206A to the scrubber and filtering system. Alternatively, translation (movement) of the mold halves 204B and translation (movement) of the mechanism 226 do not occur simultaneously and may occur serially.

FIG. 7E shows a fourth phase of the molding cycle of the molding system 200 of FIG. 7A. The insert-forming assembly 224 translates the paint-spraying mechanism 226 away from the mold half 204A. Then, the mold-moving assembly 220 is translated away from the primary mold half 202 (both movements may occur simultaneously, near simultaneously or may occur serially one after the other). The mold-moving assembly 220 rotates the mold halves 204A and 204B so that mold half 204B faces the paint-removing assembly 228. The paint-removing assembly 228 is translated toward the mold half 204B and into contact with the mold half 204B. After contact is made, the assembly 228 cleans and removes debris from the mold surface 206B of the mold half 204B and the mold half 204B is made ready for another painting cycle. The EOAT 218 grabs and removes the molded article 210 from the primary mold half 202. The cycle of the molding system 200 may be repeated by repeating the third phase and the fourth phase of FIGS. 7D and 7E respectively. The technical effect of the seventh embodiment is improved efficiency of molding operation.

According to an eighth embodiment, there is provided an article of manufacture for directing a data processing system to control a molding system 10, 61, 64, 66, 72, 100, 200 that is operatively connected to the data processing system. The article of manufacture may be a floppy disk, an optically-readable disk, a hard drive or RAM memory of the data processing system. The article of manufacture may also be a signal transmitted over a network, such as the Internet.

The article of manufacture includes a data processing system usable medium embodies one or more instructions executable by the data processing system. The one or more instructions includes i instructions for directing the data processing system to control a primary mold half 12, 102, 202 in cooperation with a secondary mold half 14A, 14B, 104, 204A, 204B, and also includes ii instructions for directing the data processing system to control the secondary mold half 14A, 14B, 104, 204A, 204B to define a mold surface 110, 206A, 206B configured to have a formable insert 16A, 16B, 16C, 16E, 112, 208A, 208B formed thereon, move relative to the primary mold half 12, 102, 202, and mold, in cooperation with the primary mold half 12, 102, 202, a molding material 18A, 18B, 210 onto the insert 16A, 16B, 16C, 16E, 112, 208A, 208B formed onto the mold surface 110, 206A, 206B.

Other instructions include control of the molding system 10, 61, 64, 66, 72, 100, 200, such as, but not limited to:

(i) for directing the data processing system to control each secondary mold half 14A, 14B, 104, 204A, 204B of the set of secondary mold halves to move relative to the primary mold half 12, 102, 202, and mold, in cooperation with the primary mold half 12, 102, 202, the molding material 18A, 18B, 210 onto the insert 16A, 16B, 16C, 16E, 112, 208A, 208B formed onto the mold surface 110, 206A, 206B;

(ii) for directing the data processing system to control formation of the insert 16A, 16B, 16C, 16E, 112 on the mold surface 110 by an application of differential-air pressure onto to the insert 16A, 16B, 16C, 16E, 112, and the differential-air pressure is configured to urge the insert 16A, 16B, 16C, 16E, 112 onto each mold surface 110.

(iii) for directing the data processing system to control receiving of the insert 16A, 16B, 16C, 16E, 112, 208A, 208B at an offline position 108 relative to the primary mold half 12, 102, 202;

(iv) for directing the data processing system to control molding, at an inline position 106 relative to the primary mold half 12, 102, 202, the molding material 18A, 18B, 210 onto the insert 16A, 16B, 16C, 16E, 112, 208A, 208B;

(v) for directing the data processing system to control receiving the insert 16A, 16B, 16C, 16E, 112, 208A, 208B onto the mold surface 110, 206A, 206B from an insert-forming assembly 44, 68, 74, 224;

(vi) for directing the data processing system to control a mold-moving assembly 20, 220, the mold-moving assembly 20, 220 for supporting and moving any one of the primary mold half 12, 102, 202, the secondary mold half 14A, 14B, 104, 204A, 204B and any combination and permutation thereof;

(vii) for directing the data processing system to control the mold-moving assembly 20, 220 to any one of rotate along a vertically aligned rotation axis, rotate along a horizontally aligned rotation axis, and translate linearly;

(vii) for directing the data processing system to control a die-cutting assembly 70, the a die-cutting assembly 70 for removing excess material from the molding material 18A, 18B from to the insert 16A, 16B, 16C, 16E, 112, cutting an interior portion of the insert 16A, 16B, 16C, 16E, 112 combined with a molding material 18A, 18B overmolded onto the insert 16A, 16B, 16C, 16E, 112, and any combination and permutation thereof.

The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A molding system (10; 61; 64; 66; 72; 100; 200), comprising:
a primary mold half (12; 102; 202); and
a secondary mold half (14A; 14B; 104; 204A; 204B) configured to:
(i) define a mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), a molding material (18A; 18B; 210) onto the insert (16A; 16B; 16C; 16E; 112; 208A; 208B) formed onto the mold surface (110; 206A; 206B);
an injection unit (28; 216) configured to inject the molding material (18A; 18B; 210) into a cavity defined by the primary mold half (12; 102; 202) and the secondary mold half (14A; 14B; 104; 204A; 204B); and
an insert-forming assembly (44; 68; 74; 224) configured to form the formable insert (16A; 16B; 16C; 16E; 112; 208A; 208B) onto the secondary mold half (14A; 14B; 104; 204A; 204B).

2. The molding system (10; 61; 64; 66; 72; 100; 200) of claim 1, wherein the secondary mold half (14A; 14B; 104; 204A; 204B) is a member of a set of secondary mold halves, each secondary mold half (14A; 14B; 104; 204A; 204B) of the set of secondary mold halves configured to:
(i) define the mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

3. The molding system (10; 61; 64; 66; 72; 100) of claim 1, wherein the mold surface (110) is configured to have:
the insert (16A; 16B; 16C; 16E; 112) thermo-formed thereon,
the insert (16A; 16B; 16C; 16E; 112) cold-formed thereon, and
any combination and permutation thereof.

4. The molding system (10; 61; 64; 66; 72; 100) of claim 1, wherein the insert (16A; 16B; 16C; 16E; 112) is formed on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

5. The molding system (10; 61; 64; 66; 72; 100; 200) of claim 1, wherein the mold surface (110; 206A; 206B) is configured to:
receive the insert (16A; 16B; 16C; 16E; 112; 208A; 208B) at an offline position (108) relative to the primary mold half (12; 102; 202), and
mold, at an inline position (106) relative to the primary mold half (12; 102; 202), the molding material (18A; 18B; 210) onto the insert (16A; 16B; 16C; 16E; 112; 208A; 208B).

6. The molding system (10; 61; 64; 66; 72; 100; 200) of claim 1, wherein the mold surface (110; 206A; 206B) is configured to receive the insert (16A; 16B; 16C; 16E; 112; 208A; 208B) from an insert-forming assembly (44; 68; 74; 224).

7. The molding system (10; 61; 64; 66; 72; 100; 200) of claim 1, wherein the insert (16A; 16B; 16C; 16E; 112; 208A; 208B) is any one of a decorative sheet, a film, a fabric-laden sheet, a decal, a painted film, a sheet, a fabric, a layer of paint and any combination and permutation thereof.

8. The molding system (10; 61; 64; 66; 72; 100; 200) of claim 1, wherein any one of the primary mold half (12; 102; 202), the secondary mold half (14A; 14B; 104; 204A; 204B) and any combination and permutation thereof is configured to be supported and moved by a mold-moving assembly (20; 220), and wherein the mold-moving assembly (20; 220) is configured to any one of:
rotate along a vertically aligned rotation axis,
rotate along a horizontally aligned rotation axis, and
translate linearly.

9. The molding system (10; 61; 64; 66; 72; 100) of claim 1, wherein the mold surface (110) of the secondary mold half (14A; 14B; 104) is configured to receive the insert (16A; 16B; 16C; 16E; 112) from an insert-forming assembly (44; 68; 74), and wherein any one of the insert-forming assembly (44; 68; 74), the secondary mold half (14A; 14B; 104) and any combination and permutation thereof is configured to apply differential-air pressure onto the insert (16A; 16B; 16C; 16E; 112).

10. The molding system (10; 61; 64; 66; 72; 100) of claim 1, wherein the secondary mold half (14A; 14B; 104; 204A; 204B) is configured to cooperate with a die-cutting assembly (70), the die-cutting assembly (70) is configured to:
remove excess material from the molding material (18A; 18B; 210) from to the insert (16A; 16B; 16C; 16E; 112; 208A; 208B),
cut an interior portion of the insert (16A; 16B; 16C; 16E; 112; 208A; 208B) combined with a molding material (18A; 18B; 210) overmolded onto the insert (16A; 16B; 16C; 16E; 112; 208A; 208B), and
any combination and permutation thereof.

11. A molding system (10; 61; 64; 66; 72; 100; 200), comprising:
a primary mold half (12; 102; 202) configured to cooperate with a secondary mold half (14A; 14B; 104; 204A; 204B), the secondary mold half (14A; 14B; 104; 204A; 204B) configured to:
(i) define a mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), a molding material (18A; 18B; 210) onto the insert (16A; 16B; 16C; 16E; 112; 208A; 208B) formed onto the mold surface (110; 206A; 206B).

12. The molding system (10; 61; 64; 66; 72; 100; 200) of claim 11, wherein the secondary mold half (14A; 14B; 104; 204A; 204B) is a member of a set of secondary mold halves, each secondary mold half (14A; 14B; 104; 204A; 204B) of the set of secondary mold halves configured to:
(i) define the mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

13. The molding system (10; 61; 64; 66; 72; 100) of claim 11, wherein the mold surface (110) is configured to have:
an insert (16A; 16B; 16C; 16E; 112) thermo-formed thereon,
an insert (16A; 16B; 16C; 16E; 112) cold-formed thereon, and
any combination and permutation thereof.

14. The molding system (10; 61; 64; 66; 72; 100) of claim 11, wherein the insert (16A; 16B; 16C; 16E; 112) is formed on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

15. The molding system (10; 61; 64; 66; 72; 100; 200) of claim 11, wherein the mold surface (110; 206A; 206B) is configured to:
receive the insert (16A; 16B; 16C; 16E; 112; 208A; 208B) at an offline position (108) relative to the primary mold half (12; 102; 202), and
mold, at an inline position (106) relative to the primary mold half (12; 102; 202), the molding material (18A; 18B; 210) onto the insert (16A; 16B; 16C; 16E; 112; 208A; 208B).

16. The molding system (10; 61; 64; 66; 72; 100; 200) of claim 11, wherein the mold surface (110; 206A; 206B) is configured to receive the insert (16A; 16B; 16C; 16E; 112; 208A; 208B) from an insert-forming assembly (44; 68; 74; 224).

17. The molding system (10; 61; 64; 66; 72; 100; 200) of claim 11, wherein the insert (16A; 16B; 16C; 16E; 112; 208A; 208B) is any one of a decorative sheet, a film, a fabric-laden sheet, a decal, a painted film, a sheet, a fabric, a layer of paint and any combination and permutation thereof.

18. The molding system (10; 61; 64; 66; 72; 100; 200) of claim 11, wherein any one of the primary mold half (12; 102; 202), the secondary mold half (14A; 14B; 104; 204A; 204B) and any combination and permutation thereof is configured to be supported and moved by a mold-moving assembly (20; 220), and wherein the mold-moving assembly (20; 220) is configured to any one of:
rotate along a vertically aligned rotation axis,
rotate along a horizontally aligned rotation axis, and
translate linearly.

19. The molding system (10; 61; 64; 66; 72; 100) of claim 11, wherein the mold surface (110) of the secondary mold half (14A; 14B; 104) is configured to receive the insert (16A; 16B; 16C; 16E; 112) from an insert-forming assembly (44; 68; 74), and wherein any one of the insert-forming assembly (44; 68; 74), the secondary mold half (14A; 14B; 104) and any combination and permutation thereof is configured to apply differential-air pressure onto the insert (16A; 16B; 16C; 16E; 112).

20. The molding system (10; 61; 64; 66; 72; 100) of claim 11, wherein the secondary mold half (14A; 14B; 104) is configured to cooperate with a die-cutting assembly (70), the die-cutting assembly (70) is configured to:
remove excess material from the molding material (18A; 18B) from to the insert (16A; 16B; 16C; 16E; 112),
cut an interior portion of the insert (16A; 16B; 16C; 16E; 112) combined with a molding material (18A; 18B) overmolded onto the insert (16A; 16B; 16C; 16E; 112), and
any combination and permutation thereof.

21. A molding system (10; 61; 64; 66; 72; 100; 200), comprising:
a secondary mold half (14A; 14B; 104; 204A; 204B) configured to:
(i) cooperate with a primary mold half (12; 102; 202);
(ii) define a mold surface (110; 206A; 206B) configured to have a formable insert (16A; 16B; 16C; 16E; 112; 208A; 208B) formed thereon,
(iii) move relative to the primary mold half (12; 102; 202), and
(iv) mold, in cooperation with the primary mold half (12; 102; 202), a molding material (18A; 18B; 210) onto the insert (16A; 16B; 16C; 16E; 112; 208A; 208B) formed onto the mold surface (110; 206A; 206B).

22. The molding system (10; 61; 64; 66; 72; 100; 200) of claim 21, wherein the secondary mold half (14A; 14B; 104; 204A; 204B) is a member of a set of secondary mold halves, each secondary mold half (14A; 14B; 104; 204A; 204B) of the set of secondary mold halves configured to:
(i) define the mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

23. The molding system (10; 61; 64; 66; 72; 100) of claim 21, wherein the mold surface (110) is configured to have:
an insert (16A; 16B; 16C; 16E; 112) thermo-formed thereon,
an insert (16A; 16B; 16C; 16E; 112) cold-formed thereon, and
any combination and permutation thereof.

24. The molding system (10; 61; 64; 66; 72; 100) of claim 21, wherein the insert (16A; 16B; 16C; 16E; 112) is formed on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

25. The molding system (10; 61; 64; 66; 72; 100; 200) of claim 21, wherein the mold surface (110; 206A; 206B) is configured to:
receive the insert (16A; 16B; 16C; 16E; 112; 208A; 208B) at an offline position (108) relative to the primary mold half (12; 102; 202), and
mold, at an inline position (106) relative to the primary mold half (12; 102; 202), the molding material (18A; 18B; 210) onto the insert (16A; 16B; 16C; 16E; 112; 208A; 208B).

26. The molding system (10; 61; 64; 66; 72; 100; 200) of claim 21, wherein the mold surface (110; 206A; 206B) is configured to receive the insert (16A; 16B; 16C; 16E; 112; 208A; 208B) from an insert-forming assembly (44; 68; 74; 224).

27. The molding system (10; 61; 64; 66; 72; 100; 200) of claim 21, wherein the insert (16A; 16B; 16C; 16E; 112; 208A; 208B) is any one of a decorative sheet, a film, a fabric-laden sheet, a decal, a painted film, a sheet, a fabric, and a layer of paint and any combination and permutation thereof.

28. The molding system (10; 61; 64; 66; 72; 100; 200) of claim 21, wherein any one of the primary mold half (12; 102; 202), the secondary mold half (14A; 14B; 104; 204A; 204B) and any combination and permutation thereof is configured to be supported and moved by a mold-moving assembly (20; 220), and wherein the mold-moving assembly (20; 220) is configured to any one of:
rotate along a vertically aligned rotation axis,
rotate along a horizontally aligned rotation axis, and
translate linearly.

29. The molding system (10; 61; 64; 66; 72; 100) of claim 21, wherein the mold surface (110) of the secondary mold half (14A; 14B; 104) is configured to receive the insert (16A; 16B; 16C; 16E; 112) from an insert-forming assembly (44; 68; 74), and wherein any one of the insert-forming assembly (44; 68; 74), the secondary mold half (14A; 14B; 104) and any combination and permutation thereof is configured to apply differential-air pressure onto the insert (16A; 16B; 16C; 16E; 112).

30. The molding system (10; 61; 64; 66; 72; 100) of claim 21, wherein the secondary mold half (14A; 14B; 104) is configured to cooperate with a die-cutting assembly (70), the die-cutting assembly (70) is configured to:
remove excess material from the molding material (18A; 18B) from to the insert (16A; 16B; 16C; 16E; 112),
cut an interior portion of the insert (16A; 16B; 16C; 16E; 112) combined with a molding material (18A; 18B; 210) overmolded onto the insert (16A; 16B; 16C; 16E; 112), and
any combination and permutation thereof.

31. A molding system (10; 61; 64; 66; 72; 100; 200), comprising:
an insert-forming assembly (44; 68; 74; 224) configured to form a formable insert (16A; 16B; 16C; 16E; 112; 208A; 208B) onto a secondary mold half (14A; 14B; 104; 204A; 204B), the secondary mold half (14A; 14B; 104; 204A; 204B) configured to:
(i) define a mold surface (110; 206A; 206B) configured to have a formable insert (16A; 16B; 16C; 16E; 112; 208A; 208B) formed thereon,
(ii) move relative to a primary mold half (12; 102; 202), and
(iii) mold, in cooperation with the primary mold half (12; 102; 202), a molding material (18A; 18B; 210) onto the insert (16A; 16B; 16C; 16E; 112; 208A; 208B) formed onto the mold surface (110; 206A; 206B).

32. The molding system (10; 61; 64; 66; 72; 100; 200) of claim 31, wherein the secondary mold half (14A; 14B; 104; 204A; 204B) is a member of a set of secondary mold halves, each secondary mold half (14A; 14B; 104; 204A; 204B) of the set of secondary mold halves configured to:
(i) define the mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

33. The molding system (10; 61; 64; 66; 72; 100) of claim 31, wherein the mold surface (110) is configured to have:
an insert (16A; 16B; 16C; 16E; 112) thermo-formed thereon,
an insert (16A; 16B; 16C; 16E; 112) cold-formed thereon, and
any combination and permutation thereof.

34. The molding system (10; 61; 64; 66; 72; 100) of claim 31, wherein the insert (16A; 16B; 16C; 16E; 112) is formed on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

35. The molding system (10; 61; 64; 66; 72; 100; 200) of claim 31, wherein the mold surface (110; 206A; 206B) is configured to:
receive the insert (16A; 16B; 16C; 16E; 112; 208A; 208B) at an offline position (108) relative to the primary mold half (12; 102; 202), and
mold, at an inline position (106) relative to the primary mold half (12; 102; 202), the molding material (18A; 18B; 210) onto the insert (16A; 16B; 16C; 16E; 112; 208A; 208B).

36. The molding system (10; 61; 64; 66; 72; 100; 200) of claim 31, wherein the mold surface (110; 206A; 206B) is configured to receive the insert (16A; 16B; 16C; 16E; 112; 208A; 208B) from an insert-forming assembly (44; 68; 74; 224).

37. The molding system (10; 61; 64; 66; 72; 100; 200) of claim 31, wherein the insert (16A; 16B; 16C; 16E; 112; 208A; 208B) is any one of a decorative sheet, a film, a fabric-laden sheet, a decal, a painted film, a sheet, a fabric, a layer of paint and any combination and permutation thereof.

38. The molding system (10; 61; 64; 66; 72; 100; 200) of claim 31, wherein any one of the primary mold half (12; 102; 202), the secondary mold half (14A; 14B; 104; 204A; 204B) and any combination and permutation thereof is configured to be supported and moved by a mold-moving assembly (20; 220), and wherein the mold-moving assembly (20; 220) is configured to any one of:
rotate along a vertically aligned rotation axis,
rotate along a horizontally aligned rotation axis, and
translate linearly.

39. The molding system (10; 61; 64; 66; 72; 100) of claim 31, wherein the mold surface (110) of the secondary mold half (14A; 14B; 104) is configured to receive the insert (16A; 16B; 16C; 16E; 112) from an insert-forming assembly (44; 68; 74), and wherein any one of the insert-forming assembly (44; 68; 74), the secondary mold half (14A; 14B; 104) and any combination and permutation thereof is configured to apply differential-air pressure onto the insert (16A; 16B; 16C; 16E; 112).

40. The molding system (10; 61; 64; 66; 72; 100) of claim 31, wherein the secondary mold half (14A; 14B; 104) is configured to cooperate with a die-cutting assembly (70), the die-cutting assembly (70) is configured to:
remove excess material from the molding material (18A; 18B) from to the insert (16A; 16B; 16C; 16E; 112),
cut an interior portion of the insert (16A; 16B; 16C; 16E; 112) combined with a molding material (18A; 18B) overmolded onto the insert (16A; 16B; 16C; 16E; 112), and
any combination and permutation thereof.

41. A molding system (10; 61; 64; 66; 72; 100; 200), comprising:
an injection unit (28; 216) configured to inject molding material (18A; 18B; 210) into a cavity defined by a primary mold half (12; 102; 202) and a secondary mold half (14A; 14B; 104; 204A; 204B), the secondary mold half (14A; 14B; 104; 204A; 204B) configured to:
(i) define a mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), a molding material (18A; 18B; 210) onto the insert (16A; 16B; 16C; 16E; 112; 208A; 208B) formed onto the mold surface (110; 206A; 206B).

42. The molding system (10; 61; 64; 66; 72; 100; 200) of claim 41, wherein the secondary mold half (14A; 14B; 104; 204A; 204B) is a member of a set of secondary mold halves, each secondary mold half (14A; 14B; 104; 204A; 204B) of the set of secondary mold halves configured to:
(i) define the mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

43. The molding system (10; 61; 64; 66; 72; 100) of claim 41, wherein the mold surface (110) is configured to have:
an insert (16A; 16B; 16C; 16E; 112) thermo-formed thereon,
an insert (16A; 16B; 16C; 16E; 112) cold-formed thereon, and
any combination and permutation thereof.

44. The molding system (10; 61; 64; 66; 72; 100) of claim 41, wherein the insert (16A; 16B; 16C; 16E; 112) is formed on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

45. The molding system (10; 61; 64; 66; 72; 100; 200) of claim 41, wherein the mold surface (110; 206A; 206B) is configured to:
receive the insert (16A; 16B; 16C; 16E; 112; 208A; 208B) at an offline position (108) relative to the primary mold half (12; 102; 202), and
mold, at an inline position (106) relative to the primary mold half (12; 102; 202), the molding material (18A; 18B; 210) onto the insert (16A; 16B; 16C; 16E; 112; 208A; 208B).

46. The molding system (10; 61; 64; 66; 72; 100; 200) of claim 41, wherein the mold surface (110; 206A; 206B) is configured to receive the insert (16A; 16B; 16C; 16E; 112; 208A; 208B) from an insert-forming assembly (44; 68; 74; 224).

47. The molding system (10; 61; 64; 66; 72; 100; 200) of claim 41, wherein the insert (16A; 16B; 16C; 16E; 112; 208A; 208B) is any one of a decorative sheet, a film, a fabric-laden sheet, a decal, a painted film, a sheet, a fabric, a layer of paint and any combination and permutation thereof.

48. The molding system (10; 61; 64; 66; 72; 100; 200) of claim 41, wherein any one of the primary mold half (12; 102; 202), the secondary mold half (14A; 14B; 104; 204A; 204B) and any combination and permutation thereof is configured to be supported and moved by a mold-moving assembly (20; 220), and wherein the mold-moving assembly (20; 220) is configured to any one of:
rotate along a vertically aligned rotation axis,
rotate along a horizontally aligned rotation axis, and
translate linearly.

49. The molding system (10; 61; 64; 66; 72; 100) of claim 41, wherein the mold surface (110) of the secondary mold half (14A; 14B; 104) is configured to receive the insert (16A; 16B; 16C; 16E; 112) from an insert-forming assembly (44; 68; 74), and wherein any one of the insert-forming assembly (44; 68; 74), the secondary mold half (14A; 14B; 104) and any combination and permutation thereof is configured to apply differential-air pressure onto the insert (16A; 16B; 16C; 16E; 112).

50. The molding system (10; 61; 64; 66; 72; 100) of claim 41, wherein the secondary mold half (14A; 14B; 104) is configured to cooperate with a die-cutting assembly (70), the die-cutting assembly (70) is configured to:
remove excess material from the molding material (18A; 18B) from to the insert (16A; 16B; 16C; 16E; 112),
cut an interior portion of the insert (16A; 16B; 16C; 16E; 112) combined with a molding material (18A; 18B) overmolded onto the insert (16A; 16B; 16C; 16E; 112), and
any combination and permutation thereof.

51. A manufactured article, comprising:
a body including a molding material (18A; 18B; 210) molded relative to a formable insert (16A; 16B; 16C; 16E; 112; 208A; 208B), the body molded by a molding system (10; 61; 64; 66; 72; 100; 200) having a primary mold half (12; 102; 202) and having a secondary mold half (14A; 14B; 104; 204A; 204B), the secondary mold half (14A; 14B; 104; 204A; 204B) configured to:
(i) define a mold surface (110; 206A; 206B) configured to have the formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

52. The manufactured article of claim 51, wherein the secondary mold half (14A; 14B; 104; 204A; 204B) is a member of a set of secondary mold halves, each secondary mold half (14A; 14B; 104; 204A; 204B) of the set of secondary mold halves configured to:
(i) define the mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

53. The manufactured article of claim 51, wherein the mold surface (110) is configured to have:
an insert (16A; 16B; 16C; 16E; 112) thermo-formed thereon,
an insert (16A; 16B; 16C; 16E; 112) cold-formed thereon, and
any combination and permutation thereof.

54. The manufactured article of claim 51, wherein the insert (16A; 16B; 16C; 16E; 112) is formed on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

55. The manufactured article of claim 51, wherein the mold surface (110; 206A; 206B) is configured to:
receive the insert (16A; 16B; 16C; 16E; 112; 208A; 208B) at an offline position (108) relative to the primary mold half (12; 102; 202), and
mold, at an inline position (106) relative to the primary mold half (12; 102; 202), the molding material (18A; 18B; 210) onto the insert (16A; 16B; 16C; 16E; 112; 208A; 208B).

56. The manufactured article of claim 51, wherein the mold surface (110; 206A; 206B) is configured to receive the insert (16A; 16B; 16C; 16E; 112; 208A; 208B) from an insert-forming assembly (44; 68; 74; 224).

57. The manufactured article of claim 51, wherein the insert (16A; 16B; 16C; 16E; 112; 208A; 208B) is any one of a decorative sheet, a film, a fabric-laden sheet, a decal, a painted film, a sheet, a fabric, a layer of paint and any combination and permutation thereof.

58. The manufactured article of claim 51, wherein any one of the primary mold half (12; 102; 202), the secondary mold half (14A; 14B; 104; 204A; 204B) and any combination and permutation thereof is configured to be supported and moved by a mold-moving assembly (20; 220), and wherein the mold-moving assembly (20; 220) is configured to any one of:
rotate along a vertically aligned rotation axis,
rotate along a horizontally aligned rotation axis, and
translate linearly.

59. The manufactured article of claim 51, wherein the mold surface (110) of the secondary mold half (14A; 14B; 104) is configured to receive the insert (16A; 16B; 16C; 16E; 112) from an insert-forming assembly (44; 68; 74), and wherein any one of the insert-forming assembly (44; 68; 74), the secondary mold half (14A; 14B; 104) and any combination and permutation thereof is configured to apply differential-air pressure onto the insert (16A; 16B; 16C; 16E; 112).

60. The manufactured article of claim 51, wherein the secondary mold half (14A; 14B; 104) is configured to cooperate with a die-cutting assembly (70), the die-cutting assembly (70) is configured to:
remove excess material from the molding material (18A; 18B) from to the insert (16A; 16B; 16C; 16E; 112),
cut an interior portion of the insert (16A; 16B; 16C; 16E; 112) combined with a molding material (18A; 18B) overmolded onto the insert (16A; 16B; 16C; 16E; 112), and
any combination and permutation thereof.

61. A molding process, comprising:
configuring a primary mold half (12; 102; 202) to cooperate with a secondary mold half (14A; 14B; 104; 204A; 204B);
defining a mold surface (110; 206A; 206B) on the secondary mold half (14A; 14B; 104; 204A; 204B) to have a formable insert (16A; 16B; 16C; 16E; 112; 208A; 208B) formed thereon;
moving the secondary mold half (14A; 14B; 104; 204A; 204B) relative to the primary mold half (12; 102; 202); and
molding, in cooperation with the primary mold half (12; 102; 202), a molding material (18A; 18B; 210) onto the insert (16A; 16B; 16C; 16E; 112; 208A; 208B) formed onto the mold surface (110; 206A; 206B) of the secondary mold half (14A; 14B; 104; 204A; 204B).

62. The molding process of claim 61, further comprising:
configuring the secondary mold half (14A; 14B; 104; 204A; 204B) to be a member of a set of secondary mold halves;
configuring each secondary mold half (14A; 14B; 104; 204A; 204B) of the set of secondary mold halves to:
(i) define the mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

63. The molding process of claim 11, further comprising:
configuring the mold surface (110) to have:
an insert (16A; 16B; 16C; 16E; 112) thermo-formed thereon,
an insert (16A; 16B; 16C; 16E; 112) cold-formed thereon, and
any combination and permutation thereof.

64. The molding process of claim 61, further comprising: forming the insert (16A; 16B; 16C; 16E; 112) on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

65. The molding process of claim 61, further comprising:
receiving the insert (16A; 16B; 16C; 16E; 112; 208A; 208B) at an offline position (108)
relative to the primary mold half (12; 102; 202); and
molding, at an inline position (106) relative to the primary mold half (12; 102; 202), the molding material (18A; 18B; 210) onto the insert (16A; 16B; 16C; 16E; 112; 208A; 208B).

66. The molding process of claim 61, further comprising: receiving the insert (16A; 16B; 16C; 16E; 112; 208A; 208B) from an insert-forming assembly (44; 68; 74; 224) onto the mold surface (110; 206A; 206B).

67. The molding process of claim 61, wherein the insert (16A; 16B; 16C; 16E; 112; 208A; 208B) is any one of a decorative sheet, a film, a fabric-laden sheet, a decal, a painted film, a sheet, a fabric, a layer of paint and any combination and permutation thereof.

68. The molding process of claim 61, wherein any one of the primary mold half (12; 102; 202), the secondary mold half (14A; 14B; 104; 204A; 204B) and any combination and permutation thereof is configured to be supported and moved by a mold-moving assembly (20; 220), and wherein the mold-moving assembly (20; 220) is configured to any one of:
rotate along a vertically aligned rotation axis,
rotate along a horizontally aligned rotation axis, and
translate linearly.

69. The molding process of claim 61, further comprising:
receiving the insert (16A; 16B; 16C; 16E; 112) from an insert-forming assembly (44; 68; 74) onto the mold surface (110) of the secondary mold half (14A; 14B; 104); and
applying differential-air pressure onto the insert (16A; 16B; 16C; 16E; 112; 208A; 208B) from any one of the insert-forming assembly (44; 68; 74), the secondary mold half (14A; 14B; 104) and any combination and permutation thereof.

70. The molding process of claim 61, further comprising: removing excess material from the molding material (18A; 18B) from to the insert (16A; 16B; 16C; 16E; 112).

71. The molding process of claim 61, further comprising: cutting an interior portion of the insert (16A; 16B; 16C; 16E; 112) combined with a molding material (18A; 18B) overmolded onto the insert (16A; 16B; 16C; 16E; 112).

72. An article of manufacture for directing a data processing system to control a molding system (10; 61; 64; 66; 72; 100; 200) operatively connected to the data processing system, the article of manufacture comprising:
a data processing system usable medium embodying one or more instructions executable by the data processing system, the one or more instructions including:
instructions for directing the data processing system to control a primary mold half (12; 102; 202) in cooperation with a secondary mold half (14A; 14B; 104; 204A; 204B); and
instructions for directing the data processing system to control the secondary mold half (14A; 14B; 104; 204A; 204B) to:
(i) define a mold surface (110; 206A; 206B) configured to have a formable insert (16A; 16B; 16C; 16E; 112; 208A; 208B) formed thereon,
(ii) move relative to the primary mold half (12; 102; 202), and
(iii) mold, in cooperation with the primary mold half (12; 102; 202), a molding material (18A; 18B; 210) onto the insert (16A; 16B; 16C; 16E; 112; 208A; 208B) formed onto the mold surface (110; 206A; 206B).

73. The article of manufacture of claim 72, wherein the secondary mold half (14A; 14B; 104; 204A; 204B) is a member of a set of secondary mold halves that each defines the mold surface (110; 206A; 206B) configured to have a formable insert (16A; 16B; 16C; 16E; 112; 208A; 208B) formed thereon, and
wherein the one or more instructions further includes instructions for directing the data processing system to control each secondary mold half (14A; 14B; 104; 204A; 204B) of the set of secondary mold halves to:
(i) move relative to the primary mold half (12; 102; 202), and
(ii) mold, in cooperation with the primary mold half (12; 102; 202), the molding material (18A; 18B; 210) onto the insert (16A; 16B; 16C; 16E; 112; 208A; 208B) formed onto the mold surface (110; 206A; 206B).

74. The article of manufacture of claim 72, further comprising:
instructions for directing the data processing system to control formation of the insert (16A; 16B; 16C; 16E; 112) on the mold surface (110) by an application of differential-air pressure onto to the insert (16A; 16B; 16C; 16E; 112), and the differential-air pressure is configured to urge the insert (16A; 16B; 16C; 16E; 112) onto each mold surface (110).

75. The article of manufacture of claim 72, further comprising:
instructions for directing the data processing system to control receiving of the insert (16A; 16B; 16C; 16E; 112; 208A; 208B) at an offline position (108) relative to the primary mold half (12; 102; 202), and
instructions for directing the data processing system to control molding, at an inline position (106) relative to the primary mold half (12; 102; 202), the molding material (18A; 18B; 210) onto the insert (16A; 16B; 16C; 16E; 112; 208A; 208B).

76. The article of manufacture of claim 72, further comprising:
instructions for directing the data processing system to control receiving the insert (16A; 16B; 16C; 16E; 112; 208A; 208B) onto the mold surface (110; 206A; 206B) from an insert-forming assembly (44; 68; 74; 224).

77. The article of manufacture of claim 72, further comprising:
instructions for directing the data processing system to control a mold-moving assembly (20; 220), the mold-moving assembly (20; 220) for supporting and moving any one of the primary mold half (12; 102; 202), the secondary mold half (14A; 14B; 104; 204A; 204B) and any combination and permutation thereof, and
instructions for directing the data processing system to control the mold-moving assembly (20; 220) to any one of:
rotate along a vertically aligned rotation axis,
rotate along a horizontally aligned rotation axis, and
translate linearly.

78. The article of manufacture of claim 72, further comprising:
instructions for directing the data processing system to control a die-cutting assembly (70) to:
remove excess material from the molding material (18A; 18B) from to the insert (16A; 16B; 16C; 16E; 112),
cut an interior portion of the insert (16A; 16B; 16C; 16E; 112) combined with a molding material (18A; 18B) overmolded onto the insert (16A; 16B; 16C; 16E; 112), and
any combination and permutation thereof.
